(19) United States
(12) Patent Application Publication
(10) Pub. No.: US 2013/0109349 A1
(43) Pub. Date: May 2, 2013

(54) MOBILE IDENTITY VERIFICATION

(71) Applicant: Rahul Iyengar, Union City, CA (US)

(72) Inventor: Rahul Iyengar, Union City, CA (US)

(73) Assignee: MOBITV, INC., Emeryville, CA (US)

(21) Appl. No.: 13/282,014

(22) Filed: Oct. 26, 2011

(51) Int. Cl. H04W 12/06

(52) U.S. Cl. 455/411

(57) ABSTRACT

According to various embodiments, verifying a mobile identity includes obtaining a mobile identifier, a user name, and a password. The mobile identifier is verified using a verification sequence such as double opt-in process. The mobile identifier is associated with the user name and the password at a content server. The user name and the password are periodically requested and the mobile identifier is periodically reobtained in order to authorize the user to continue to access an application such as a mobile media application.

### TECHNICAL FIELD

The present disclosure relates to mobile identity verification.

### DESCRIPTION OF RELATED ART

A variety of media content providers use an internet connection with a user of a mobile device to provide services and media content to the user. If the media content provider can verify the user's identity, then the media content provider can provide the user with the requested services. When the media content provider communicates with the mobile device through a carrier network, carrier network headers are inserted by the carrier into HTTP requests originating from the mobile device operated by the user. The carrier network headers may be used to verify the user's identity. However, this is not possible when carrier network headers are not available. For example, if the media content provider and the user's mobile device are connected through a Wi-Fi network, the carrier's network is not used, and carrier network headers are not available. In this situation, the content provider may use application programming interface calls originating on the mobile device to gather information about the user. However, the application code on the device is not secure, and may be easily comprised. Thus, ascertaining a user's identity in the absence of carrier network headers remains insecure and unreliable.

### BRIEF DESCRIPTION OF THE DRAWINGS

The disclosure may best be understood by reference to the following description taken in conjunction with the accompanying drawings, which illustrate particular embodiments.

FIG. 1 illustrates an example of process 100, in which the mobile identity of a user is verified using a mobile device.

FIG. 2 illustrates an example of process 200, in which a media content provider verifies the mobile identity of a user by sending the user a short message service (SMS) message.

FIG. 3 illustrates an example of process 300, in which a media content provider verifies the mobile identity of a user by receiving a short message service (SMS) message from the user.

FIG. 4 illustrates an example of system 400 that may be used to verify a user's mobile identity.

FIG. 5 is a diagrammatic representation showing one example of media content delivery server 591.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular types of content. However, it should be noted that the techniques of the present invention apply to a wide variety of content. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, verifying a mobile identity includes obtaining a mobile identifier, a user name, and a password. The mobile identifier is verified using a verification sequence such as double opt-in process. The mobile identifier is associated with the user name and the password at a content server. The user name and the password are periodically requested and the mobile identifier is periodically reobtained in order to authorize the user to continue to access an application such as a mobile media application.

In particular embodiments, the verification sequence is included in a first short message service (SMS) message sent from the media content delivery server to the mobile device. In various embodiments, the verification sequence may already be present on the mobile device. Thus, according to particular embodiments, a first SMS message is not required.

In various embodiments, the verification sequence is sent to the media content delivery server from the mobile device to verify the mobile identity of the user to the media content delivery server. This may occur after the verification sequence has been executed on the mobile device.

### Example Embodiments

A media content provider may provide various media content to a user operating a mobile device. However, to allow the user access to such media content, the media content provider may first verify the mobile identity of the user. The mobile identity of the user may be verified when the media content provider verifies both the identity of a specific user, and the identity of a specific mobile device operated by the user. Conventional methods of verifying the mobile identity of the user rely upon information provided by cellular phone carriers. For example, if the media content provider and the mobile device communicate through a carrier network, the media content provider may rely upon network headers inserted by the carrier into HTTP requests made by the mobile device. The network headers are specific to the mobile device and the user operating the mobile device. Thus, the network headers provide sufficient information for the media content provider to verify the mobile identity of the user.

However, if the media content provider and the mobile device do not use a carrier network to communicate, then the information provided by network headers is not available. For example, if the media content provider and the mobile device communicate through a Wi-Fi network, then network headers are not available. In such a situation, the media content provider may have to rely on other information to verify the identity of the user. For example, the media content provider may rely upon an application running on the mobile device to retrieve information from the mobile device. However, on an open mobile platform, such as the Android platform, applications are not secure and may be easily compromised. If the application is compromised, then media content may be distributed to unauthorized users or mobile devices. Thus, information provided by applications may be unreliable and insufficient to verify the user's mobile identity.

According to various embodiments of the present disclosure, a process outside the normal processes of an application running on the mobile device ensures that the mobile identity of a user may be verified. According to various embodiments, an application running on a mobile device may receive a user name and a password corresponding to a user of the mobile device. The user name and password may be used to verify the identity of the user. The application may use various application program interface calls to retrieve a mobile identifier corresponding to the mobile device. The mobile identifier may be used to verify the identity of the mobile device. The application may then execute a verification sequence to verify the mobile identity of the user. The verification sequence associates the user's identity with the mobile identity. According to various embodiments, the verification sequence is used by the application to verify the mobile identity of the user to a media content delivery server.

In particular embodiments, the verification sequence is included in a first short message service (SMS) message sent from the media content delivery server to the mobile device. Upon startup of an application on the mobile device, the application may prompt the user for a user name and password which may be used to verify the identity of the user. A first SMS message including the verification sequence may be sent to the mobile device. The user may respond to the verification sequence. The response may include entering a user name and password, or entering a pin number. The response may be sent back to the media content provider in a second SMS message. By responding to the first SMS message, the user may verify that the correct mobile identifier was used to send the first SMS message. Thus, the identity of the mobile device may be verified. Accordingly, the executed verification sequence included in the second SMS message may provide sufficient information to verify the user's mobile identity.

In various embodiments, the verification sequence may already be present on the mobile device. Thus, according to particular embodiments, a first SMS message is not required. The application may receive a user name and password, and retrieve a mobile identifier from the mobile device. The application may then execute the verification sequence. As before, execution of the verification sequence may be used to verify the identity of the user, and associate the identity of the user with the retrieved mobile identifier. The application may then send a SMS message including the executed verification sequence to the media content provider. The SMS message may also include a mobile identifier specific to the mobile device used to send the SMS message. Accordingly, the executed verification sequence and mobile identifier included in the SMS message may provide sufficient information to verify the user's mobile identity.

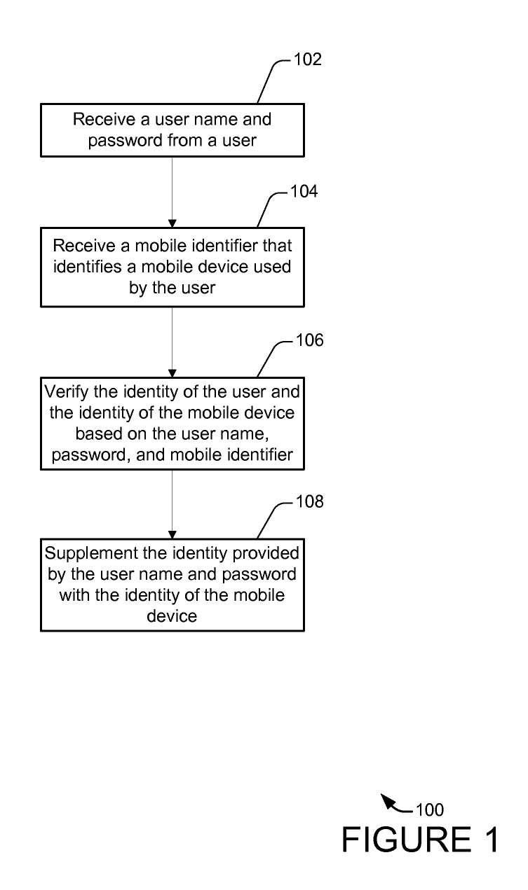

FIG. 1 illustrates an example of process 100, in which the mobile identity of a user is verified using a mobile device. A user's mobile identity may provide verification of the user's identity and verification of the identity of the mobile device the user is using. Thus, a media content provider may use a user's mobile identity to verify that only a particular user using a particular mobile device has access to services and content provided by the media content provider. Accordingly, a user's mobile identity may authenticate a user to a media content provider, authorize a user to access content managed by the media content provider, and process payments made by the user to the media content provider.

At the beginning of process 100, a user may start an application on a mobile device. The application may be provided by the media content provider. In various embodiments, the application run on the mobile device may provide the media content provider with the ability to verify a user's identity while the user is using the mobile device. For example, the user may have previously established an account with the media content provider. When establishing his or her account, the user may have subscribed to a particular service provided by the media content provider. The service may entail providing various entertainment programs to the user's mobile device. A user name and password may associate the user with the account. The user name and password may be selected when the user set up his or her account. Thus, the user name and password may be used to verify the user's identity and retrieve account information associated with the user, such as a list of services and content that the user may access. It will be appreciated that while a user name and password may be used to associate a user with an account, any information could be used. For example, billing information or other personal information could be used to establish the user's identity.

Accordingly, at step 102, the application running on the mobile device may receive a user name and password when supplied by the user of the mobile device. The user may supply this information in response to the application requesting the user name and password. As previously discussed, the application may request any information that may be linked to a user's account, such as billing information or account information specific to the user. According to various embodiments, once the user name and password have been received, the media content provider may use the information provided to the application to verify the identity of the user of the mobile device.

At step 104, the application running on the mobile device may retrieve a mobile identifier corresponding to the mobile device. A mobile identifier may be a piece of information specific to the mobile device being used by the user. The mobile identifier may, for example, be a phone number associated with the mobile device. Furthermore, the mobile identifier may also be an international mobile equipment identity (IMEI), a mobile equipment identifier (MEID), or an electronic serial number (ESN). Moreover, the mobile identifier may include several pieces of information. For example, the mobile identity may include a phone number associated with the mobile device as well as the IMEI and ESN. Because the mobile identifier is specific to that particular mobile device, the mobile identifier may be used to by the media content provider to verify the identity of the mobile device.

At step 106, the application running on the mobile device may verify the user's mobile identity on the mobile device by executing a verification sequence. The verification sequence may associate the user's identity with the identity of the mobile device to create the user's mobile identity. The verification sequence may be a data sequence, such as a code, certificate, or pin number. Thus, according to various embodiments, execution of the verification sequence may involve a sequence of steps that requires the user to verify his or her identity while using the mobile device. For example, the application running on the mobile device may request that the user enter his or her user name and password, or a pin number. The user may enter this information to verify his or her identity. The executed verification sequence may then be included in a message that will be sent to a media content delivery server operated by the media content provider. The message may also include information verifying the identity of the mobile device, such as its mobile identifier. Because the message may include information that verifies both the identity of the user, and the identity of the mobile device, the message may include sufficient information to verify the user's mobile identity.

In particular embodiments, execution of the verification sequence may occur without action from the user. For example, the verification sequence may prompt the application to retrieve the user name and password already entered upon startup of the application. Thus, execution of the verification sequence may occur according to a process that is transparent to the user.

At step 108, the application running on the mobile device may send the verification sequence to a media content delivery server. As previously discussed, the message including the verification sequence includes information that verifies both the identity of the user of the mobile device, and the identity of the mobile device itself. Once the verification sequence has been received, and the mobile identity of the user has been verified, the media content provider may provide media content to the user of the mobile device in accordance with the terms of the user's subscription. In various embodiments, process 100 may be repeated periodically and for every monetary transaction associated with the service requested by the user.

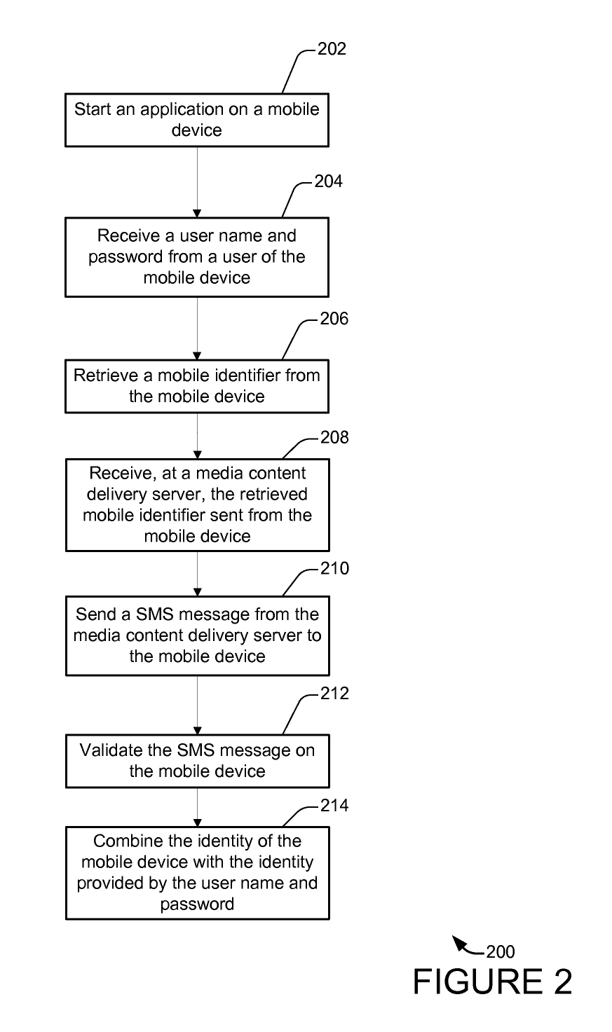

FIG. 2 illustrates an example of process 200, in which a media content provider verifies the mobile identity of a user by sending the user a short message service (SMS) message.

At step 202, an application provided by the media content provider may be started on a mobile device. At step 204, the application may receive a user name and password from the user of the mobile device. At step 206, the application may retrieve a mobile identifier from the mobile device. In various embodiments, once the user name, password, and mobile identifier are received and retrieved, they are sent to a media content delivery server operated by the media content provider.

At step 208, the media content delivery server may receive the retrieved mobile identifier from the mobile device. The media content delivery server may use the mobile identifier to determine where to send a verification sequence. Thus, in various embodiments, the media content delivery server uses a phone number retrieved from the mobile device to determine where to send a SMS message including the verification sequence.

At step 210, the media content delivery server may send a SMS message including the verification sequence to the mobile device. The verification sequence may be received by the mobile device as a text message. In particular embodiments, the verification sequence may prompt the user of the mobile device for an action. For example, the verification sequence included in the SMS message may request that the user enters a pin number, or some other piece of information that is specific to the user associated with the user name and password initially provided at step 204. In various embodiments, no action is required by the user. Instead, the application running on the mobile device may supply information that has already been entered by the user.

At step 212, the application running on the mobile device may validate the user's mobile identity. In various embodiments, the application may receive the user's response to the verification sequence. In particular embodiments, the application may provide the response to the verification sequence based upon previous input provided by the user or other information accessible by the application. Because the verification sequence requires information specific to the user, execution of the verification sequence may verify the identity of the user. Moreover, because a specific mobile identifier was used to send the verification sequence to the user, execution of the verification sequence also verifies the identity of the mobile device. Thus, execution of the verification sequence may verify the user's mobile identity. The application may include the executed verification sequence in a SMS message to send back to the media content server. The application may subsequently prompt the mobile device to send the SMS message to the media content server.

Upon receiving the SMS message, at step 214, the media content server may associate the user's user name and password with the mobile identifier to verify the user's mobile identity. Thus, according to various embodiments, the media content server may store the user name, password, and mobile identifier in a data base as the user's mobile identity.

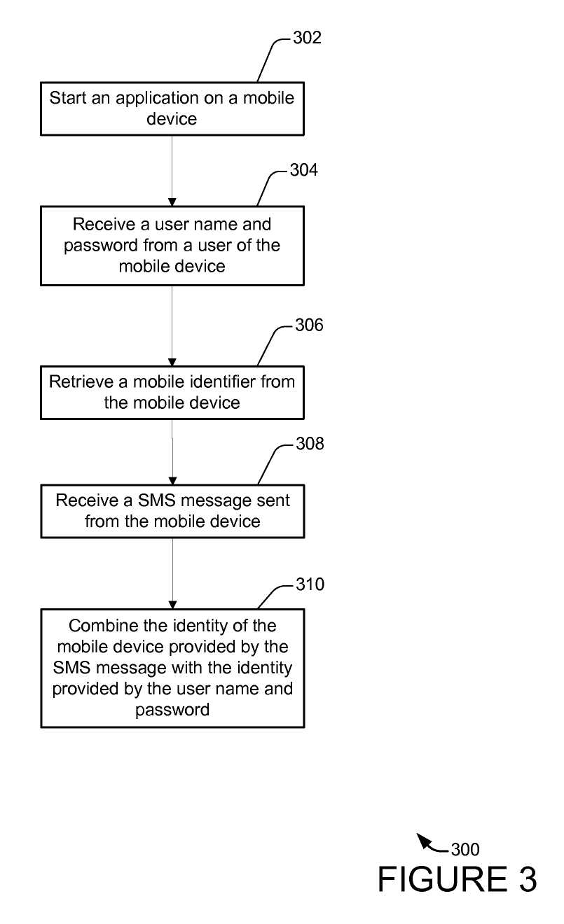

FIG. 3 illustrates an example of process 300, in which a media content provider verifies the mobile identity of a user by receiving a short message service (SMS) message from the user.

At step 302 an application provided by a media content provider may be started on a mobile device. At step 304, the application may receive a user name and password associated with the user of the mobile device. At step 306, the application may retrieve a mobile identifier from the mobile device.

At step 308, an SMS message sent from the mobile device may be received at a media content delivery server. An application running on the mobile device may be used to generate the SMS message. The application may use a verification sequence that is already present on the mobile device to verify the user's mobile identity. In various embodiments, the verification sequence may have been included with the application when it was originally downloaded and installed. In particular embodiments, the verification sequence may have been previously downloaded during a previous use of the application. Thus, according to various embodiments, validation of the user's mobile identity is not responsive to a SMS message sent by the media content delivery server. Instead, the application running on the mobile device may execute a verification sequence already present on the mobile device. The application may use the results of the executed verification sequence in conjunction with the user's user name and password to generate a SMS message that is sent to the media content delivery server operated by the media content provider. Thus, the resulting SMS message includes information specific to the user's identity and the mobile device's identity that is used by the media content provider to verify the user's mobile identity.

At step 310, the media content server may combine the identity of the mobile device provided by the SMS message with the identity provided by the user name and password. Thus, the media content server may associate the user's user name and password with the mobile identifier to verify the user's mobile identity. As discussed above, the media content delivery server may store the user name, password, and mobile identifier in a data base as the user's mobile identity.

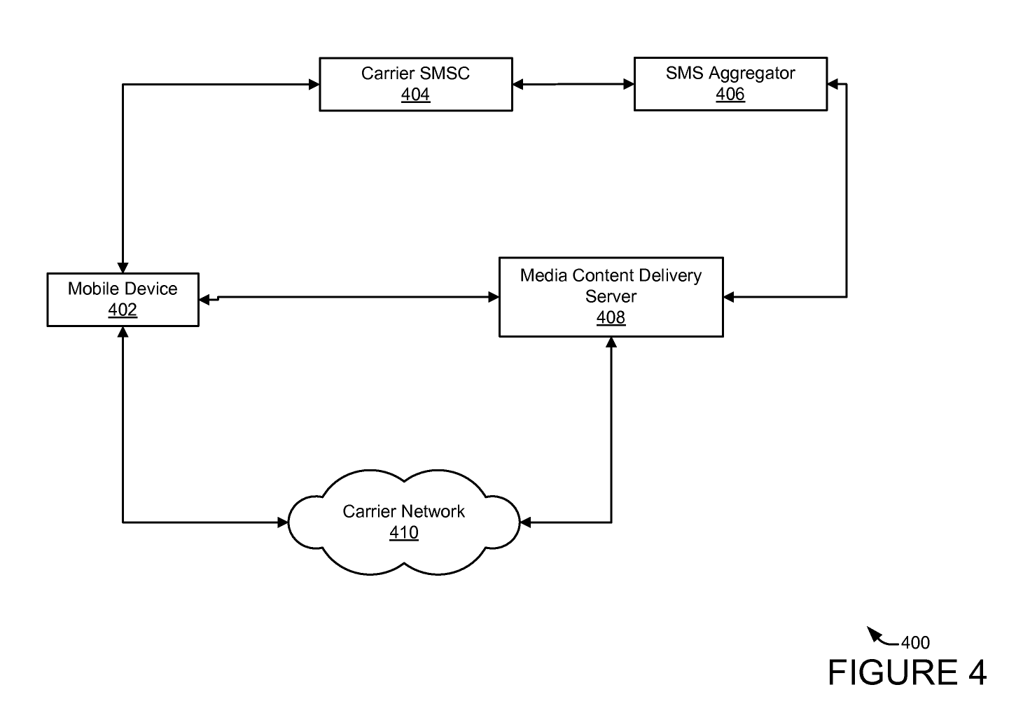

FIG. 4 illustrates an example of system 400 that may be used to verify a user's mobile identity. System 400 may include mobile device 402, media content delivery server 408, carrier short message service center (SMSC) 404, short message service (SMS) aggregator 406, and carrier network 410.

Mobile device 402 may be operated by a user. In various embodiments, mobile device 402 may be a cellular phone. Mobile device 402 may be capable of running various forms of media. For example, entertainment programming may be provided to mobile device 402 through an internet connection. Thus, mobile device 402 may display entertainment programming that is downloaded or streamed over the internet.

Media content delivery server 408 may store media content, such as entertainment programming. Media content delivery server 408 may also monitor and control access to the media content stored therein. For example, a user may require a valid account and a verified mobile identity to access the media content stored in media content delivery server 408. Media content delivery server 408 may be in communication with mobile device 402 and provide media content to mobile device 402 when the user operating mobile device 402 has the requisite access.

Mobile device 402 and media content delivery server 408 may communicate with each other and exchange SMS messages through carrier SMSC 404 and SMS aggregator 406. For example, mobile device 402 may send a SMS message to carrier SMSC 404. Carrier SMSC 404 may handle SMS operations for a wireless network. Thus, carrier SMSC 404 may receive the SMS message from mobile device 402 over a wireless network and subsequently send the SMS message to SMS aggregator 406. SMS aggregator 406 may serve as a gateway between carrier SMSC 404 and media content delivery server 408. Accordingly, SMS aggregator 406 may send the SMS message to media content delivery server 408. It will be appreciated that the reverse path may also be possible. For example, media content delivery server 408 may send a SMS message to mobile device 402 through SMS aggregator 406 and carrier SMSC 404.

Mobile device 402 and media content delivery server 408 may also communicate with each other through carrier network 410. Carrier network 410 may be a communications network operated by a cellular phone service provider. When communicating with mobile device 402 through carrier network 410, media content delivery server 408 may have access to header information, and other information specific to the user of the mobile device. However, when mobile device 402 and media content delivery server 408 do not communicate through carrier network 410, such information is not available. This may be the case when mobile device 402 and media content delivery server 408 communicate through a Wi-Fi network.

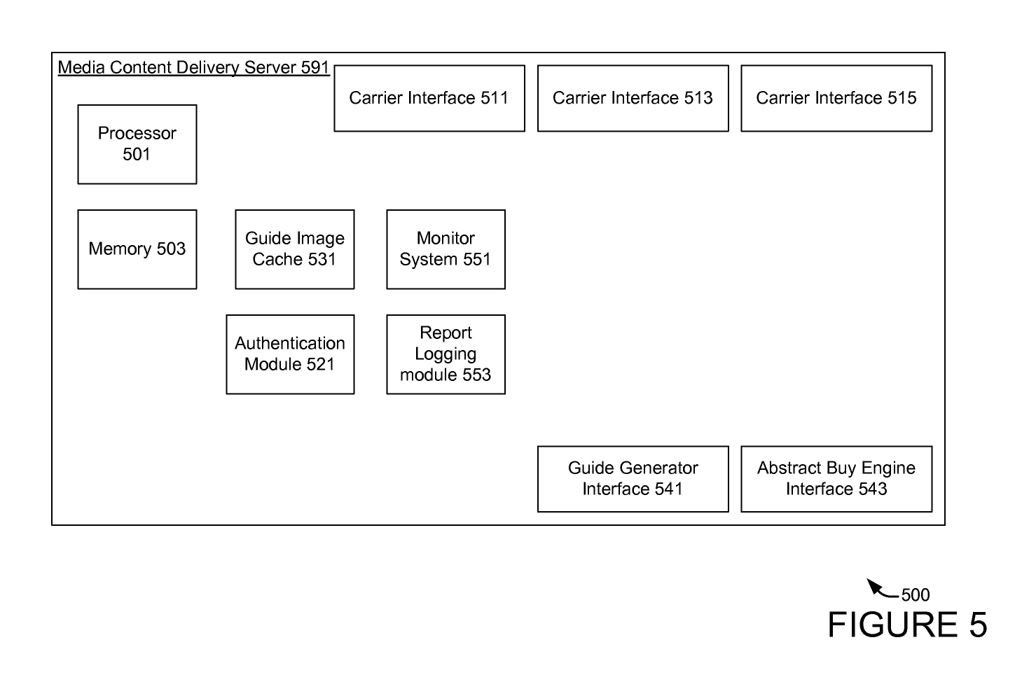

FIG. 5 is a diagrammatic representation showing one example of media content delivery server 591. According to various embodiments, the media content delivery server 591 includes a processor 501, memory 503, and a number of interfaces. In some examples, the interfaces include a guide generator interface 541 allowing the media content delivery server 591 to obtain program guide information. The media content delivery server 591 also can include a program guide cache 531 configured to store program guide information and data associated with various channels. The media content delivery server 591 can also maintain static information such as icons and menu pages. The interfaces also include a carrier interface 511 allowing operation with mobile devices such as cellular phones operating in a particular cellular network. The carrier interface allows a carrier vending system to update subscriptions. Carrier interfaces 513 and 515 allow operation with mobile devices operating in other wireless networks. An abstract buy engine interface 543 provides communication with an abstract buy engine that maintains subscription information.

An authentication module 521 verifies the identity of mobile devices. A logging and report generation module 553 tracks mobile device requests and associated responses. A monitor system 551 allows an administrator to view usage patterns and system availability. According to various embodiments, the media content delivery server 591 handles requests and responses for media content related transactions while a separate streaming server provides the actual media streams. In some instances, a media content delivery server 591 may also have access to a streaming server or operate as a proxy for a streaming server. But in other instances, a media content delivery server 591 does not need to have any interface to a streaming server. In typical instances, however, the media content delivery server 591 also provides some media streams. The media content delivery server 591 can also be configured to provide media clips and files to a user in a manner that supplements a streaming server.

Although a particular media content delivery server 591 is described, it should be recognized that a variety of alternative configurations are possible. For example, some modules such as a report and logging module 553 and a monitor 551 may not be needed on every server. Alternatively, the modules may be implemented on another device connected to the server. In another example, the server 591 may not include an interface to an abstract buy engine and may in fact include the abstract buy engine itself. A variety of configurations are possible.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

1. A method comprising:
obtaining a mobile identifier corresponding to a mobile device;
verifying a mobile identity of a user by transmitting a verification sequence to the mobile device, wherein the mobile identity of the user is verified upon receiving a response sequence from the mobile device;
receiving a user name and password from the mobile device;
associating the mobile identifier with the user name and the password associated with the user;
periodically requesting the user name and the password from the user; and
periodically reobtaining the mobile identifier to verify that the mobile identifier, user name, and password still correspond to allow continued access to a mobile media application.

2. The method of claim 1, wherein the verification sequence is included in a first short message service (SMS) message sent from a media content delivery server to the mobile device, and wherein the response sequence is sent back to the media content delivery server in a second SMS message.

3. The method of claim 2, wherein the response sequence is sent to the media content delivery server from the mobile device to verify the mobile identity of the user to the media content delivery server.

4. The method of claim 1, wherein the verification sequence is entered into an application communicating with the media content delivery server to verify the mobile identity of the user to the media content delivery server.

5. The method of claim 1, wherein the application is a media application.

6. The method of claim 1, wherein the mobile identifier is selected from the group consisting of: a phone number, an international mobile equipment identity (IMEI), a mobile equipment identifier (MEID), and an electronic serial number (ESN).

7. The method of claim 1, wherein the user name and the password is associated with the mobile identifier at the media content delivery server.

8. The method of claim 1, wherein the media content delivery server determines whether the mobile device is provisioned to receive media content.

9. The method of claim 1, wherein reobtaining the mobile identifier to verify that the mobile identifier, user name, and password still correspond to the same user allows the user to continue accessing a media application.

10. A system comprising:
an interface configured to obtain a mobile identifier corresponding to a mobile device;
a processor configured to verify a mobile identity of a user by transmitting a verification sequence to the mobile device, wherein the mobile identity of the user is verified upon receiving a response sequence from the mobile device and receiving a user name and password from the mobile device;
memory configured to maintain and association between the mobile identifier and the user name and the password associated with the user;
wherein the user name and the password are periodically requested from the user and the mobile identifier is periodically reobtained to verify that the mobile identifier, user name, and password still correspond to allow continued access to a mobile media application.

11. The system of claim 10, wherein the verification sequence is included in a first short message service (SMS) message sent from a media content delivery server to the mobile device, and wherein the response sequence is sent back to the media content delivery server in a second SMS message.

12. The system of claim 11, wherein the response sequence is sent to the media content delivery server from the mobile device to verify the mobile identity of the user to the media content delivery server.

13. The system of claim 10, wherein the verification sequence is entered into an application communicating with the media content delivery server to verify the mobile identity of the user to the media content delivery server.

14. The system of claim 5, wherein the application is a media application.

15. The system of claim 10, wherein the mobile identifier is selected from the group consisting of: a phone number, an international mobile equipment identity (IMEI), a mobile equipment identifier (MEID), and an electronic serial number (ESN).

16. The system of claim 10, wherein the user name and the password is associated with the mobile identifier at the media content delivery server.

17. The system of claim 10, wherein the media content delivery server determines whether the mobile device is provisioned to receive media content.

18. The system of claim 10, wherein reobtaining the mobile identifier to verify that the mobile identifier, user name, and password still correspond to the same user allows the user to continue accessing a media application.

19. A system comprising:
means for retrieving a mobile identifier corresponding to a mobile device;
means for verifying a mobile identity of a user by transmitting a verification sequence to the mobile device, wherein the mobile identity of the user is verified upon receiving a response sequence from the mobile device;
means for receiving a user name and password from the mobile device;
means for associating the mobile identifier with the user name and the password associated with the user;
wherein the user name and the password are periodically requested from the user and the mobile identifier is periodically reobtained to verify that the mobile identifier, user name, and password still correspond to allow continued access to a mobile media application.

20. The system of claim 19, wherein the verification sequence is included in a first short message service (SMS) message sent from a media content delivery server to the mobile device, and wherein the response sequence is sent back to the media content delivery server in a second SMS message.
